(19) United States
(12) Patent Application Publication
(10) Pub. No.: US 2017/0243175 A1
(43) Pub. Date: Aug. 24, 2017

(54) Method of making payments for commodities in virtual currencies (i.e. BITcoin) by keeping the standard of presenting the offer of purchase in a traditional currency

(71) Applicant: Adam Gramowski, Torun (PL)

(72) Inventor: Adam Gramowski, Torun (PL)

(21) Appl. No.: 14/934,712

(22) Filed: Nov. 6, 2015

(51) Int. Cl. G06Q 20/06; G06Q 20/12

(52) U.S. Cl. CPC G06Q 20/065; G06Q 20/12; G06Q 20/3276

(57) ABSTRACT

The essence of the invention lies in the method of determining the value of a single commodity or a range of goods in the virtual currency using the values expressed in local currency and in a method of determining a supplier of exchange rates of conversions of virtual currency by the seller or the buyer, depending on restrictions imposed by the former to carry out the transaction of sale of the given product or a range of goods, using payment with virtual currency without having to change the standard of presentation of the offer by the seller.

### TECHNICAL FIELD

IT, Electronics

### STATE OF THE ART IN THE TECHNICAL FIELD OF THE INVENTION KNOWN TO THE APPLICANT AND USEFUL TO UNDERSTAND THE INVENTION

Holders of units of a virtual currency (i.e. BITcoin) have funds collected on the individual address assigned to them. Address is in fact a sequence of a certain amount of alphanumeric characters, which may take the form of an appropriate sequence, such as for Bitcoin: 13jz3PKtJhRYm8nWA87XLNKfdxJKcBy4Nt.

By the current state of the technics, there are different primary mechanisms of transfer of virtual currency's units between addresses, but there is no way that would allow their use as a means of trade while maintaining the standard of proposing an offer in a traditional currency. Units of Virtual currency are being transmitted essentially by presenting the address of the recipient among the data concerning the transfer (which is being ordered by the holder of the address) and then by the approval of the operation and its authentication (via password).

The non-existence of such a method causes that the purpose of virtual currency as the equivalent of the commodities which are to be purchased with a payment by virtual currency is that the value of the commodity must always be nominated in this virtual currency. Payment is made through transfer record for a specified number of the virtual currency from one address to another. This state of affairs makes it virtually impossible to implement any virtual currency as a means of payment, because the value of each commodity would have to be given in its units to buyers, which would constitute an extraordinary hardship for sellers who would be forced to make numerous and frequent updates. If, for example, stationary shop offering electronic equipment had to put a label with a price expressed in the virtual currency to each product, they would have to modify this price a few times per day in order not to get the virtual price ranged as high as 10% in relation to the traditional currency during the day. The process of converting the price expressed in a traditional currency into the price expressed in a virtual one would be too tedious to be used in regular trading.

None of the existing virtual currencies as a means of payment is stable enough to be used as a direct reference when it comes to the value of the commodity. It would not entail any intelligible information and would frustrate the trade. In the current prevailing state of affairs, it is thus possible to express the value of a commodity in a virtual currency and thus theoretically its use as a means of payment, but due to the absence of a method for such determination of the value of an asset while maintaining the prices denominated in the traditional currency this is not feasible and no virtual currency is suitable for use in direct sale, i.e. in retail trade.

State of the art in this technical field looks like so that there is no way to pay in the ordinary commercial trade with virtual currencies. There are only primitive forms of transferring units of the given virtual currency between specific addresses of the virtual currency units by maintaining different techniques of presenting particular and relevant information. Apart from this it should be noted that these primary mechanisms will also be used in the implementation of the system described herein because they belong to the essence of each virtual currency.

In the implementation of the system described herein, three technologies known in the current state of the art will be used. They are not directly connected with the virtual currencies. These are the following technologies: QR codes, NFC Tag and XML.

QR code is an alphanumeric, two-dimensional, matrix, square graphical code. This is a modular code for encoding characters belonging to different alphabets and other symbols specified by the user. Construction of the code allows its placement and reading on objects moving rapidly in relation to the scanner. They can be used to store information and put in different places, also i.e . . . URL addresses. Then such data can be read using respectively programmed mobile devices.

NFC Tag is a sticker or keychain holding NFC module, which is a high frequency radio communication standard allowing for wireless exchange of data over a distance of 20 centimeters. NFC devices can communicate both with existing devices in standard of ISO/IEC 14443 (cards and readers), as well as with other NFC devices, and thus they comply with existing and already in use in infrastructure of public transport and payments like MIFARE. NFC is primarily aimed at usage in mobile phones.

XML is a markup language designed to represent the data containing elements such as text, images, links, etc. in a structured way. It is used for exchanging data in the Internet.

So far in the current state of the art there has been no method of payment with virtual currencies which would permit the seller to preserve the standard of presenting the offer in a traditional currency. The method described herein is therefore strictly innovative and it cannot be referred to any process which would be known to the current state of the art. From the perspective of the described invention, the existing technical solutions are important. They allow for the transfer of funds collected in the respective virtual currency between each address. As it was mentioned earlier, these are: QR codes, NFC tag and XML—they were used for the implementation of the method presented herein.

### DESCRIPTION OF THE INVENTION'S NATURE

The essence of the invention lies in the method of determining the value of a single commodity or a range of goods in the virtual currency using the values expressed in local currency and in a method of determining a supplier of exchange rates of conversions of virtual currency by the seller or the buyer, depending on restrictions imposed by the former to carry out the transaction of sale of the given product or a range of goods, using payment with virtual currency without having to change the standard of presentation of the offer by the seller.

To implement such a process two assumptions must be fulfilled:
Each buyer will be equipped with a mobile phone with Internet access and a digital camera or NFC module, with the possibility to install the appropriate client application on the phone. The application would be, developed for the implementation of this process (ie, in particular any smartphone with Android or Windows).
Each seller conducting stationary point of sale will be equipped with a device with Internet access, with the ability to install the appropriate application developed for carrying out this process.

For proper implementation of the method described herein, the two well-known and widely used technologies should be used:
QR Codes technology or NFC Tag
Technology of sending messages in XML format.

The value expressed in virtual currency is determined on the client application of the buyer. The application is supported only with the information that the seller provided (in the form of a message in QR code or NFC tag) and with the data coming from the rate's supplier determined on the basis of this information.

In the message to the purchaser there must be at least:
Address of the virtual currency of the seller;
Price of the product expressed in local currency;
Three-letter code identifying the local currency.

Moreover the message should also contain:
URL address of extension of this message, if all of its content does not fall within that message—the further portion may be in the XML file which is available at this address
Specification of the form of a message to the seller when it comes to information about the transaction and the execution of the transfer, which may take the form of http message or title of payment of transfer of a specified number of units of the virtual currency
URL address suitable for sending the message described above, if the seller has indicated that he accepts the HTTP protocol
The proposed providers of conversion's rate, which should be used by the buyer on his application.

Importantly, if the seller in his message does not specify the suppliers of exchange rate, the buyer will determine this provider himself, and the seller while finalizing the purchase will only accept the sent amount of units of virtual currency on the basis of margins of inaccuracy defined by himself. Such a solution gives a seller an opportunity to specify preferred suppliers of exchange rate which are confronted with those proposed by the buyer (the specific methodology for the selection of particular suppliers is a matter that is not directly related to the method described herein, but it will depend on the creativity of suppliers of suitable software and the established practice).

The above mentioned shape of the messages applies to transactions concerning single products. In case of transactions on more than one product, one of the items (as specified below) should be modified accordingly:
“Price of the product, expressed in local currency”

should be replaced with:
URL directing to the prices of products.

With this modification the purchaser of goods, with the help of a mobile application is limited only to scan the barcodes of specific products. These products combined with data retrieved from the given URL will give specific prices, expressed in local currency.

At the closing of purchases the total sum of the prices of products in local currency (or the price from message while purchasing a single item or the sum of prices of goods when purchasing more than one item) is converted to the value expressed in a virtual currency on the client application of purchaser, with help of data from the agreed supplier of exchange rate.

The funds will be sent to the appropriate address of virtual currency of the seller, which confirms if the amount of units of virtual currency units corresponds to to the amount of purchases and therefore terminates the entire transaction process. The transmission of a specified number of units of virtual currency takes the path characteristic for the specific virtual currency, which is not an essential process from the perspective of the method presented herein.

The use of the method of making payments using virtual currency eliminates the difficulty that currently exists objectively when it comes to the use of virtual currency in trade. The solution presented herein would remove the problems associated primarily with determining prices or the amount of units of virtual currency to be forwarded to the address of the seller as compensation for purchased goods. With the present state of the art it is a tedious process that compels both the seller and buyer to search for exchange rates of virtual currency in relation to the traditional currency and to convert—at the agreed exchange rate—the price expressed in the traditional currency every time before carrying out the transaction, which in turn can be realized.

The implementation of the method presented herein will allow to use commonly the virtual currencies. The basic amenity that in such a situation the buyer and seller will have is that they can express the value of goods in a traditional currency. Furthermore, the implementation of such a standard of payment using virtual currency will popularize virtual currencies.

### THE EXAMPLES OF THE IMPLEMENTATION OF THE METHOD

Below you can find the examples how the method can be implemented. They are presented in sections that reflect subsequent sequences of operations that must be performed. Within the specific sections—if necessary—letter record has been used in order to indicate the relevant processes that take place within a client application of the customer wishing to purchase goods and within the server of the shop. They were designated accordingly with the letters “a” and “b”.
1. Purchase of single product on the web site.
1) The customer visit the website of the store where he can find a product which he intends to acquire. Next to the description of the product there is a QR code.
2) Using the mobile application client scans the QR code, which results in displaying information about the product on the phone screen. At the same time the client application prepares the transaction, which soon will be able to be realized (at this moment the identification number of the transaction is being made). The client application on the basis of data collected from a QR code sets the current exchange rate of a virtual currency in relation to the traditional currency and shows the customer how many units of virtual currency should be sent.
3) a) the client—after final confirmation by the client, the determined amount of units of virtual currency will be sent to the indicated address;
   b) the store's server—gets information with the identification number of transaction and data needed for the delivery from client application. Upon receipt of any payment the server verifies (by the identification number of transaction) from whom the funds have come and verifies the amount of paid units of virtual currency and then goods will be handed over for shipment, in accordance with the information the server has received from a client application.
2. Purchase of a few products in a stationary store
1) a) the customer—at the entrance he scans the QR code of the store, thus creating a transaction ID. At the same time data with the prices of products offered is being retrieved (denominated in a traditional currency) from the specified URL of the shop;
   b) the store's server—gets some information about the new client.
   2) a) the customer—scans the barcodes of products that he wants to buy and add them to the list of selected products on the client application;
   b) the store's server—receives information about the products added by the client to the basket.
   3) a) the customer—wanting to finish shopping, the cumulative value of the products the client application converts into the value expressed in a virtual currency, using one of the agreed suppliers of exchange rates among those proposed by the seller, which were also included in the data in the QR code of the store. Then the units of a virtual currency are being sent to the seller;
   b) the store's server—verifies the amount of transferred units of virtual currency and the client on the basis of the identification number

1. A method of making payments in virtual currency where the value of a single commodity or a range of goods expressed in units of the virtual currency is calculated using the value of the goods or range of goods expressed in traditional money, while maintaining the standard of presenting the offer in traditional money.

2. A method of claim 1, wherein the exchange rate's supplier to determine the value of the goods or collection of goods in a virtual currency is determined by the seller or the buyer, depending on restrictions imposed by the first one.

3. A method of claim 1, wherein the message containing the offer will be expressed in XML.

4. The method of claim 1, wherein the message containing the offer will include: price of the product expressed in traditional money or a URL directing to the prices of products, three-letter code identifying specific local currency of traditional money and address of virtual currency.
